(19) United States
(12) Patent Application Publication
(10) Pub. No.: US 2024/0157353 A1
(43) Pub. Date: May 16, 2024

(54) IONIC FUNCTIONALIZATION OF AROMATIC POLYMERS FOR ION EXCHANGE MEMBRANES

(71) Applicant: Rensselaer Polytechnic Institute, Troy, NY (US)

(72) Inventors: Chulsung Bae, Cohoes, NY (US); Eun Joo Park, Troy, NY (US); Sangtaik Noh, Troy, NY (US); Michael Pagels, Troy, NY (US)

(21) Appl. No.: 18/381,149

(22) Filed: Oct. 17, 2023

Related U.S. Application Data
(63) Continuation of application No. 17/658,627, filed on Apr. 8, 2022, now Pat. No. 11,826,746.
Application No. 17/658,627 is a continuation of application No. 16/842,037, filed on Apr. 7, 2020, now abandoned.
Application No. 16/842,037 is a continuation-in-part of application No. 16/628,879, filed on Jan. 6, 2020, now abandoned.
(60) Provisional application No. 62/652,037, filed on Apr. 3, 2018.
(60) Provisional application No. 62/652,063, filed on Apr. 3, 2018.
(60) Provisional application No. 62/647,930, filed on Mar. 26, 2018.
(60) Provisional application No. 62/529,078, filed on Jul. 6, 2017.
(60) Provisional application No. 62/832,087, filed on Apr. 10, 2019.
(60) Provisional application No. 62/830,928, filed on Apr. 8, 2019.

(51) Int. Cl. B01J 41/14; B01J 39/20; C08J 5/22; H01M 8/1032; H01M 8/1072

(52) U.S. Cl. CPC B01J 41/14; B01J 39/20; C08J 5/2287; H01M 8/1032; H01M 8/1072; H01M 2008/1095

(57) ABSTRACT

The electrochemical energy conversion system of the present disclosure includes an anode, a cathode, and an ion exchange membrane including a polymer having an aromatic polymer chain and an alkylated substrate including an alkyl chain, and at least one ionic group. The alkylated substrate is bound to at least one aromatic group in the polymer chain via Friedel-Crafts alkylation of the at least one aromatic group. The alkylation reaction utilizes a haloalkylated tertiary alcohol or a haloalkylated alkene as a precursor. In the presence of an acid catalyst, a carbocation is generated in the precursor which reacts with the aromatic rings of the polymer chain. The at least one ionic group is then replaced with a desired cationic or anionic group using a substitution reaction. The membranes exhibit advantageous stability achieved through a simplified and scalable reaction scheme.

### STATEMENT REGARDING FEDERALLY SPONSORED RESEARCH OR DEVELOPMENT

This invention was made with government support under grant nos. 1534289 and 1506245 awarded by the National Science Foundation, and grant nos. DE-AR0000769, DE-AC52-06NA25396 and A30636 awarded by the Department of Energy. The government has certain rights in the invention.

### INCORPORATION BY REFERENCE

An Application Data Sheet is filed concurrently with this specification as part of the present application. Each application that the present application claims benefit of or priority to as identified in the concurrently filed Application Data Sheet is incorporated by reference herein in its entirety and for all purposes.

### BACKGROUND

Recently anion exchange membrane (AEM) fuel cells have gained a significant interest because of faster kinetics of oxygen reduction reaction and the possibility to use nonprecious metal for electrocatalysts in alkaline operating condition compared to acidic proton exchange membrane fuel cells. Unfortunately, these potential benefits have not been realized in long-lived fuel cell devices because of the drawbacks of currently available AEMs, which include poor chemical stability in alkaline operating conditions, insufficient mechanical stability, low hydroxide conductivity, and the lack of convenient synthetic methods for rapid synthesis of these materials.

A focus of AEM research has been synthesis of anionic polymer membranes with long-term alkaline stability and high hydroxide conductivity. The durability of AEMs is heavily , dependent on the chemical stability of polymer backbone. For example, poly(arylene ether)s, the most common backbone structure of AEMs, contain aryl ether linkages and the backbone is prone to undergo chain scission in alkaline conditions by the nucleophilic attack of the hydroxide ion, significantly reducing the AEM durability. Due to good chemical stability of backbone in alkaline condition, elastic mechanical property, nanoscale phase separation morphology, and commercial availability, polystyrene-£-poly(ethylene-co-butylene)-£-polystyrene (SEBS) can serve as a promising candidate for preparation of AEMs.

However, when chloromethylation was attempted to introduce a functionality to SEBS for synthesis of AEM, the polystyrene (PS) block of SEBS has resulted in gelation or low levels of functionalization. To overcome these limitations, functionalization of SEBS for AEM applications based on transition metal-catalyzed C-H borylation and Suzuki coupling reactions has been attempted. However, the use of expensive transition metal catalysts, such as Ir and Pd, can be a major barrier to broader application of the reaction, particularly at scale.

### SUMMARY

Some embodiments of the disclosed subject matter are directed to an electrochemical energy conversion system including an anode, a cathode, and an ion exchange membrane disposed between the anode and the cathode. In some embodiments, the ion exchange membrane is a moisture diffusion membrane (sometimes referred to as a pervaporation membrane). In some embodiments, the ion exchange membrane includes comprising a polymer having an aromatic polymer chain, an alkylated substrate including a linker, an alkyl chain, and at least one ionic group, wherein the alkylated substrate is bound to at least one aromatic group in the polymer chain. In some embodiments, the alkylated substrate is attached to the aromatic polymer chain via Friedel-Crafts alkylation of the at least one aromatic group. In some embodiments, the alkylated substrate is bound by the linker to at least one aromatic group in the aromatic polymer chain via Friedel-Crafts alkylation of the at least one aromatic group with a haloalkylated precursor substrate.

In some embodiments, the aromatic polymer chain includes polystyrene, polysulfone, poly(phenylene oxide), poly(phenylene), polystyrene copolymers, polysulfone copolymers, poly(phenylene oxide) copolymers, poly(phenylene) copolymers, or combinations thereof. In some embodiments, the alkyl chain has a length of 1 to about 20 carbons. In some embodiments, the at least one ionic group includes an alkylammonium group, a sulfonate group, a phosphonate group, a carboxylate group, an amine, or an alcohol. In some embodiments, the linker is a secondary, tertiary, or quaternary carbon. In some embodiments, the haloalkylated precursor substrate includes a haloalkylated tertiary alcohol, a haloalkylated alkene, or combinations thereof. In some embodiments, the haloalkylated precursor substrate includes 7-bromo-2-methylheptan-2-ol, 6-bromo-2-methylhexan-2-ol, 5-bromo-2-methylpentan-2-ol, 6-bromo-l-hexene, 7-bromo-2-methyl-2-heptene, or combinations thereof In some embodiments, the polymer includes the structure according to formula III:

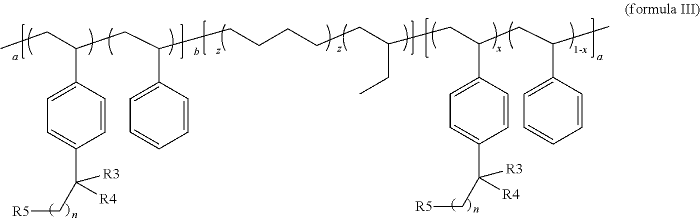

wherein R3 includes H, CH₃, or (CH₂)ₙR5, R4 includes H, CH₃, or (CH₂)ₙR5, R5 includes at least one ionic group, n=1 to about 20, a/b is about 0.05 to about 0.5 by weight of the polymer according to formula III, and x=0.05 to about 0.95.

Some embodiments of the disclosed subject matter are directed to a method of making an ion exchange membrane material including providing a reaction medium including an aromatic polymer chain, a haloalkylated precursor substrate, and an acid catalyst, the haloalkylated precursor substrate including an alkyl chain and a halide group; reacting the haloalkylated precursor substrate via Friedel-Crafts alkylation of an aromatic group in the aromatic polymer chain with the haloalkylated precursor substrate to attach the alkyl chain and the halide group to the aromatic group; and performing a substitution reaction to replace the halide group with at least one ionic group. In some embodiments, the acid catalyst includes triflic acid, trifluoroacetic acid, sulfuric acid, methanesulfonic acid, para-toluenesulfonic acid, or combinations thereof.

In another aspect, a polymer according to formula IV, is provided.

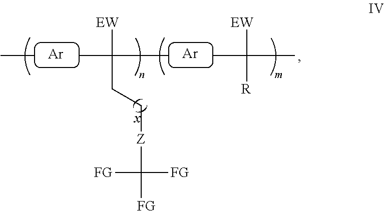

wherein Ar is an aryl;
Z is selected from the group consisting of O, S, CH₂, and C₆H₄;
R is an alkyl;
FG comprises a moiety selected from the group consisting of an alkyl, an aryl, OH, a sulfonate, a phosphonate, and a quaternary ammonium group, wherein at least one FG comprises an ionic moiety;
EW comprises a moiety selected from the group consisting of an electron-withdrawing group, CF3, a nitrile, an amide, a pyridine, a heterocyclic amine, —C═O, and an amide;
x is from 1 to 20;
n and m are each independently from 100 to 1,000,000.

In some embodiments, the polymer of formula IV is an anion exchange polymer. In some embodiments, at least one FG comprises a quaternary ammonium group. For example, at least one FG may include (CH₂)ₓ·N⁺R₁R₂R₃, wherein R₁, R₂, and R₃ is each an alkyl (e.g., methyl). In some embodiments EW is CF₃. In some embodiments, Ar in formula IV includes

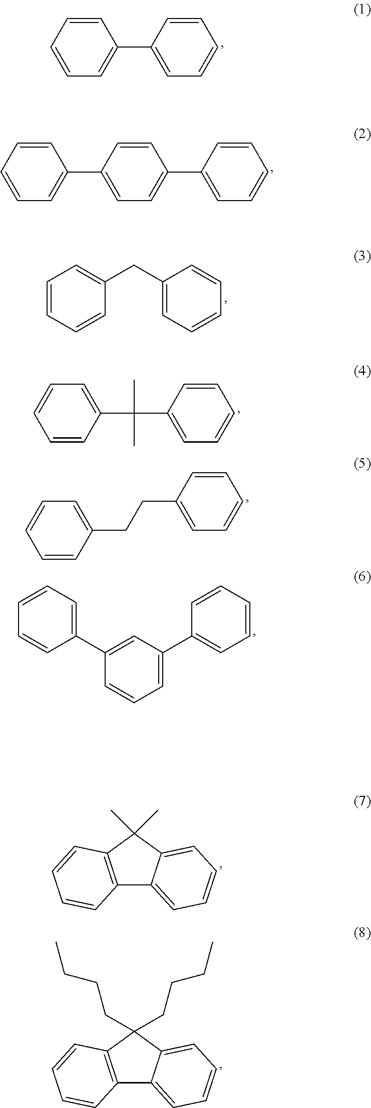

or combinations thereof.

In some embodiments the polymer of formula IV has formula V:

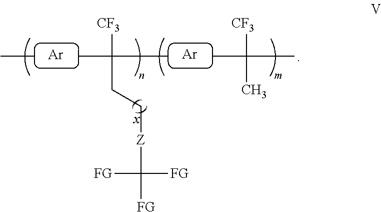

In some embodiments, the polymer is a cation exchange polymer. In some embodiments, at least two FGs in a repeating unit include an ionic moiety. In some embodiments, at least three FGs in a repeating unit include an ionic moiety.

In another aspect, a polymer according to formula VI, is provided:

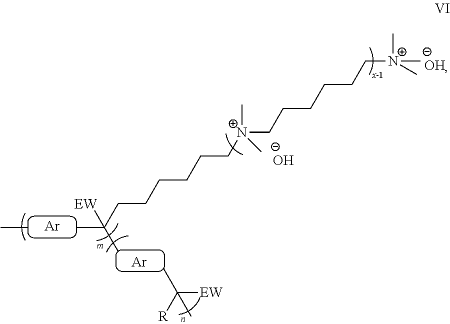

wherein Ar is an aryl;
R is an alkyl;
EW comprises a moiety selected from the group consisting of an electron-withdrawing group, CF₃, a nitrile, an amide, a pyridine, a heterocyclic amine, —C═O, and an amide;
x is from 1 to 20;
n and m are each independently from 100 to 1,000,000.

In some embodiments EW is CF₃. In some embodiments Ar in formula VI includes

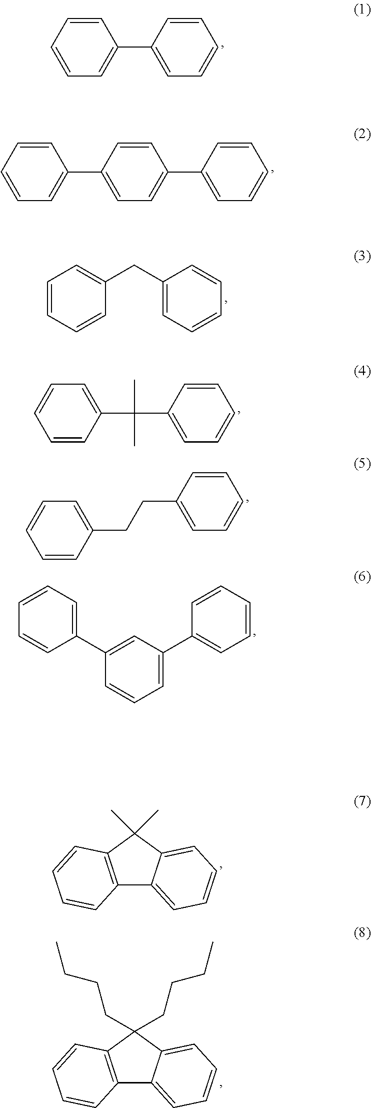

or combinations thereof.

In some embodiments the polymer of formula VI has formula VII:

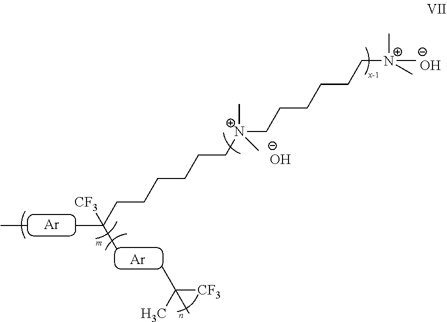

In another aspect, a polymer according to formula VIII, is provided:

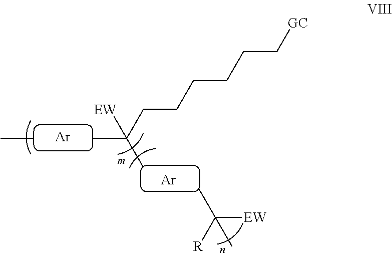

wherein GC is a graft chain comprising multiple ionic moieties;
wherein Ar is an aryl;
R is an alkyl;
EW comprises a moiety selected from the group consisting of an electron-withdrawing group, CF₃, a nitrile, an amide, a pyridine, a heterocyclic amine, —C═O, and an amide;
x is from 1 to 20;
n and m are each independently from 100 to 1,000,000.

In some embodiments the multiple ionic moieties include multiple quaternary ammonium groups. In some embodiments EW is CF₃. In some embodiments Ar in formula VIII includes:

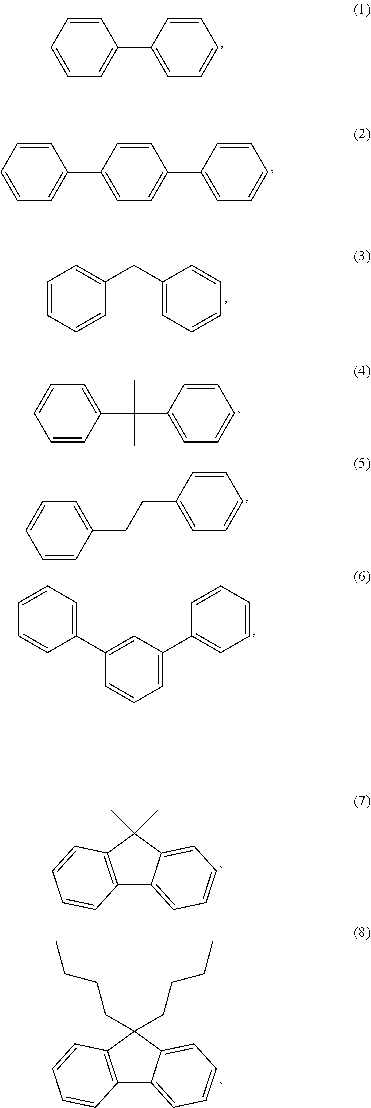

or combinations thereof.

In some embodiments R is an alkyl and EW is CF₃.

### BRIEF DESCRIPTION OF THE DRAWINGS

The drawings show embodiments of the disclosed subject matter for the purpose of illustrating the invention. However ; it should be understood that the present application is not limited to the precise arrangements and instrumentalities shown in the drawings, wherein:

FIG. 1 is a schematic drawing of an electrochemical energy conversion system including an ion exchange membrane according to some embodiments of the present disclosure;

FIG. 2A is a chart of a method for making an ion exchange membrane according to some embodiments of the present disclosure;

FIG. 2B is a chart of a method for making an ion exchange membrane according to some embodiments of the present disclosure;

FIG. 2C is a chart of a method for making an ion exchange membrane according to some embodiments of the present disclosure;

FIG. 3 is a chart showing nuclear magnetic resonance spectra for polystyrene-b-poly(ethylene-co-butylene)-h-polystyrene (SEBS) and polymers according to some embodiments of the present disclosure;

FIG. 4 is a chart of measured properties representative of some exemplary polymers according to some embodiments of the present disclosure; and

FIG. 5 is a chart of measured properties representative of some exemplary polymers according to some embodiments of the present disclosure.

FIG. 6A is a chart illustrating a linear multication graft copolymer according to some embodiments of the present disclosure.

FIG. 6B is a chart illustrating a branched multi-ion copolymer according to some embodiments of the present disclosure.

FIG. 7A is a chart illustrating a linear multication graft copolymer according to some embodiments of the present disclosure.

FIG. 7B is a chart illustrating a branched multi-ion copolymer according to some embodiments of the present disclosure.

### DETAILED DESCRIPTION

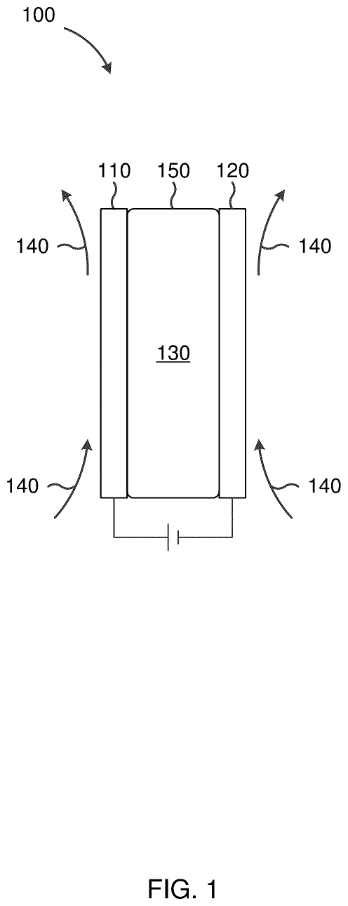

Referring now to FIG. 1, aspects of the disclosed subject matter include an electrochemical energy conversion system 100 including an anode 110, a cathode 120, and an electrolyte 130 disposed between the anode and the cathode. System 100 is suitable for use in numerous applications, such as fuel cells, energy recovery ventilation systems ; water hydrolysis systems, electrochemical hydrogen compressors, batteries, sensors, actuators, etc. In some embodiments, anode 110 and cathode 120 are composed of any suitable material for use with electrolyte 130 in system 100. Further, system 100 includes any suitable inlets/outlets 140 to supply reactants to and remove reaction products from anode 110, cathode 120, and electrolyte 130.

In some embodiments, electrolyte 130 is a solid electrolyte. in some embodiments, electrolyte 130 is an ion exchange membrane 150. In some embodiments, ion exchange membrane 150 is an anion exchange membrane or a cation exchange membrane. In some embodiments, the ion exchange membrane is a moisture diffusion membrane. In some embodiments, the ion exchange membrane 150 is at least in part composed of a functionalized base polymer. in sonic embodiments, the base polymer is an aromatic polymer, e.g., a polymer chain whose structure includes aromatic rings. At least some of the aromatic polymers are functionalized with at least one hydrocarbon chain and at least one ionic group. In some embodiments, the polymer includes the structure according to formula I:

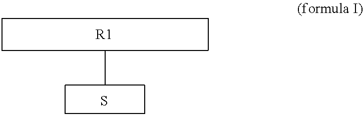

where R1 is an aromatic polymer chain and S is at least one alkylated substrate. In some embodiments, the alkylated substrate includes at least one hydrocarbon group (Ak) and at least one ionic group (R2) as generally depicted in formula II:

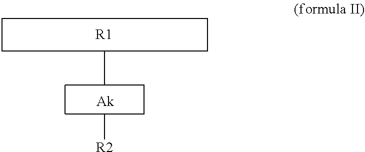

In some embodiments, S is bound to at least one aromatic group in R1. In some embodiments, the hydrocarbon group Ak of S is bound directly to the at least one aromatic group in R1. In some, S includes a linker which is bound directly to the at least one aromatic group in R1, as will also be discussed in greater detail below. In some embodiments, R2 is a head group disposed at an end of Ak.

In some embodiments, R1 includes polystyrene, polysulfone, poly(phenylene oxide), poly(phenylene), polystyrene copolymers, polysulfone copolymers, poly(phenylene oxide) copolymers, poly(phenylene) copolymers, block copolymers including polystyrene, polystilfone, or poly(phenylene oxide), poly(phenylene), or combinations thereof. In some embodiments, R1 includes polystyrene-b-poly(ethylene-co-butylene)-b-polystyrene. In some embodiments, R1 has a degree of functionalization between about 5% and about 95%, i.e., between about 5% and about 95% of the aromatic groups in R1 are functionalized with at least one S.

In some embodiments, Ak includes a hydrocarbon group having a length of 1 to about 20 carbons. In some embodiments, the hydrocarbon group has a length of about 2 to about 4 carbons. In some embodiments, the hydrocarbon group is a hydrocarbon chain (branched or unbranched), a hydrocarbon ring, or combinations thereof In some embodiments, the hydrocarbon group is fully saturated. In some embodiment, the hydrocarbon group includes at least one unsaturated carbon. In some embodiments, the hydrocarbon group is an alkyl group, e.g., an alkyl chain. In some embodiments, the alkyl chain has a length of 1 to about 2.0 carbons. In some embodiments, the alkyl chain has a length of about 2 to about 4 carbons. In some embodiments, the alkyl chain has a length of 3 carbons. In some embodiments, the at least one ionic group includes an alkylammonium group, a sulfonate group, a phosphonate group, a carboxylate group, an amine, or an alcohol. In some embodiments, the at least one ionic group includes two or more ionic groups. In some embodiments, the two or more ionic groups are the same. In some embodiments, the two or more ionic groups are different.

In some embodiments, the polymer includes the structure according to formula III:

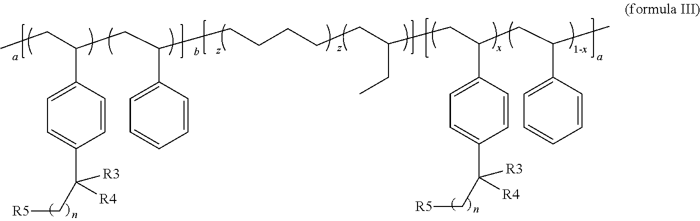

where R3 includes H, CH₃, or (CH₂)ₙR5, R4 includes H, CH₃, or (CH₂)ₙR5, R5 includes at least one ionic group, n=1 to about 20, a/b is about 0.05 to about 0.5 by weight of the polymer according to formula III, and x is at least 0.05. In some embodiments, n is about 2 to about 4. In some embodiments, n=3. In some embodiments, x is about 0.05 to about 0.95. In some embodiments, x is about 0.45 to about 0.95. In some embodiments, x is about 0.7 to about 0.9. In some embodiments, x=0.8. While the aromatic groups from formula III are shown to be functionalized at the C4 carbon, the polymers of the present disclosure are not limited in this regard, as the aromatic groups can be functionalized at any available aromatic group carbon, e.g., the C2, C3, CS, C6, or combinations thereof. In some embodiments, ion exchange membrane 150 is composed substantially entirely of material consistent with the embodiments described above. In some embodiments, the material is incorporated into or attached to a base polymeric structure, such as a commercially available membrane.

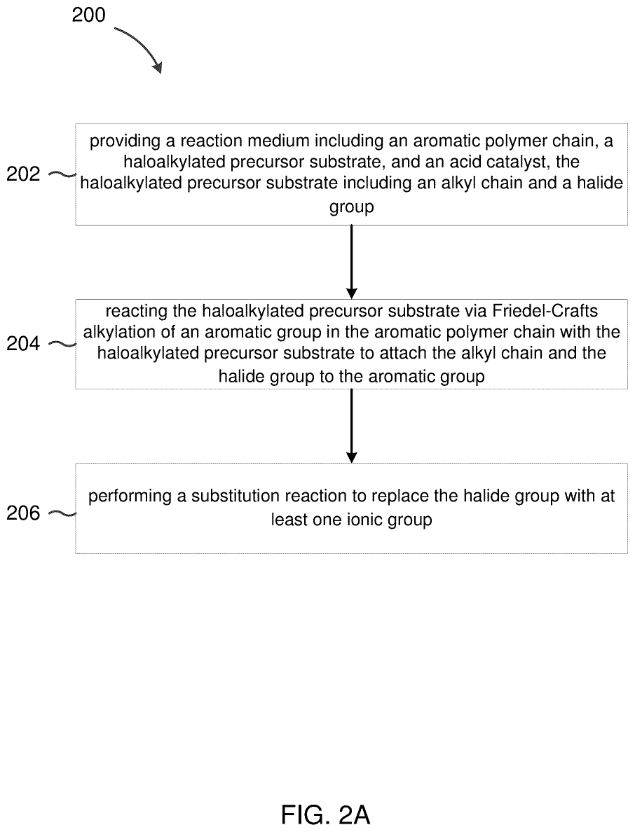

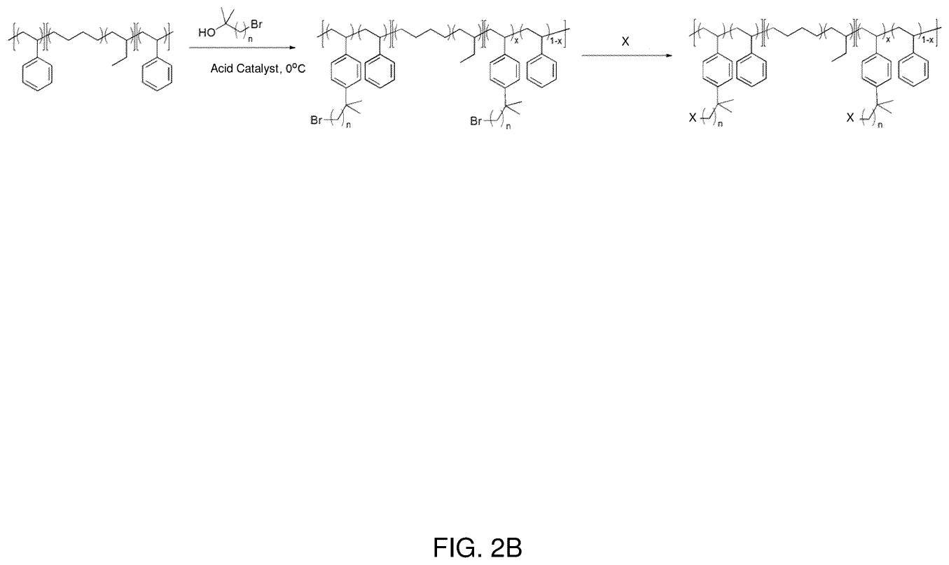

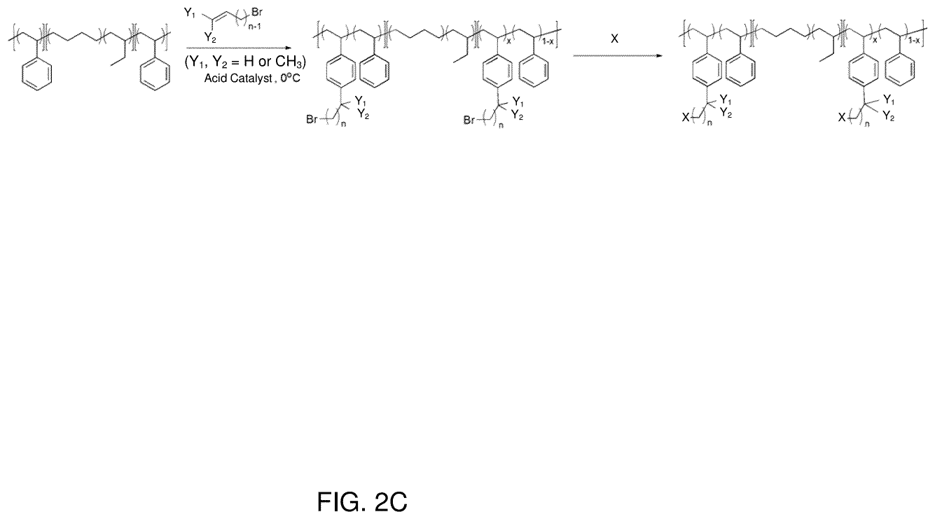

Referring now to FIG. 2A, some aspects of the disclosed subject matter include a method 200 of making an ion exchange membrane material. In some embodiments, at 202, a reaction medium is provided that includes an aromatic polymer chain and a precursor substrate. In some embodiments, the precursor substrate includes at least one hydrocarbon group and at least one ionic precursor group. As discussed above, in some embodiments, the hydrocarbon group is a hydrocarbon chain, a hydrocarbon ring, or combinations thereof. In some embodiments, the hydrocarbon group is an alkyl chain. In some embodiments, the ionic precursor group is a halide group, i.e., a group including Br, I, Cl, etc., or combinations thereof In some embodiments, the precursor substrate includes a haloalkyl group, i.e., includes an alkyl group and a halide group, which is referred to herein as a “haloalkylated precursor substrate.” In some embodiments, the precursor substrate, e.g., a haloalkylated precursor substrate, includes a reaction domain. In some embodiments, the reaction domain is configured to react with aromatic groups in the aromatic polymer chain to incorporate the hydrocarbon group and the ionic group into the polymer chain.

At 204, the precursor substrate, e.g., a haloalkylated precursor substrate, is reacted with an aromatic group in the aromatic polymer chain to attach the at least one hydrocarbon group, e.g., an alkyl chain, and the at least one ionic precursor group, e.g., a halide group, to the aromatic group. In some embodiments, reaction 204 occurs between the reaction domain and an aromatic group. In some embodiments, reaction 204 is a Friedel-Crafts alkylation reaction. In some embodiments, the reaction domain is a tertiary alcohol. In some embodiments, the reaction domain is an alkene. Therefore, in some embodiments, the precursor substrate includes a haloalkylated tertiary alcohol, a haloalkylated alkene, or combinations thereof. In some embodiments, the precursor substrate includes 7-bromo-2-methylheptan-2-ol, 6-bromo-2-methylhexan-2-o1, 5-bromo-2-methylpentan-2-ol, 6-bromo-l-hexene, 7-bromo-2-methyl-2-heptene, or combinations thereof.

In some embodiments, the reaction medium includes an acid catalyst. In some embodiments, the acid catalyst includes triflic acid, trifluoroacetic acid, sulfuric acid, methanesulfonic acid, para-toluenesulfonic acid, or combinations thereof. Without wishing to be bound by theory, during the Friedel-Crafts alkylation reaction, a carbocation is generated in the precursor substrate at the reaction domain in the presence of the acid catalysts. Referring now to FIG, 2B, for example, a haloalkylated tertiary alcohol generates a tertiary carbocation in the presence of an acid catalyst such as triflic acid. The generated tertiary carbocation then readily reacts with π electrons of the aromatic rings of the aromatic polymer chain. The result is a haloalkyl group from the haloalkylated tertiary alcohol bound to an aromatic ring of the aromatic polymer chain, in this case via a linker, e.g., a quaternary carbon. Referring now to FIG. 2C, for example, a haloalkylated alkene generates either a secondary or a tertiary carbocation in the presence of an acid catalyst such as triflic acid. The generated secondary or tertiary carbocation then readily reacts with n electrons of the aromatic rings of the aromatic polymer chain. The result is a haloalkyl group from the haloalkylated alkene bound to an aromatic ring of the aromatic polymer chain, in this case via a linker, e.g., a secondary, tertiary, or quaternary carbon.

As a result of reaction 204, at least some aromatic groups are functionalized with the hydrocarbon group having the ionic precursor group. At 206, in some embodiments, a substitution reaction is performed to replace the ionic precursor group with at least one ionic group. In some embodiments, the at least one ionic group includes an alkylammonium group, a sulfonate group, a phosphonate group, a carboxylate group, an amine, or an alcohol. The specific pendent chains and/or groups that functionalize the aromatic groups are easily tunable by tuning the precursor substrate and the substitute reaction reactants. For example, longer hydrocarbon groups in the precursor substrate can result in a longer tether length between the polymer chain and the at least one ionic group. Further, by adjusting the composition of the reaction medium during substation reaction 206, method 200 can control what ionic groups replace the precursor ionic groups, thus tuning the functionalization of the membrane.

The polymeric materials consistent with the embodiments of the present disclosure are advantageous for use as membrane materials due to their chemical stability. The method of making these polymeric materials is advantageously simplified through use of Friedel-Crafts alkylation reaction steps mentioned above to functionalize suitable aromatic polymer chains in a one or two step reaction scheme, and further allows convenient control over alkyl tether length and ion head groups during functionalization. The catalysts for use in reactions are inexpensive, and advantageously do not produce harmful, or in some cases any, byproducts.

### EXAMPLE

### Example 1: Preparation with Haloalkylated Tertiaryalcohols.

The aromatic rings of polystyrene-b-poly(ethylene-co-butylene)-b-polystyrene (SEBS) (Mn=105,000 g/mol, and Mw/Mn=1.04) with 18 mol % (30 wt. %, 25 vol. %) PS block were functionalized via acid-catalyzed Friedel-Crafts bromoalkylation as discussed above with bromoalkylated tertiary alcohols as a substrate. Without wishing to be bound by theory, as the tertiary alcohol is protonated by a Bronsted acid, it loses water as a byproduct and forms a tertiary carbocation intermediate which can readily react with the π electrons of the aromatic rings to generate bromoalkylated SEBS. Slightly more than 1 eq. of acid (1.1-1.2 eq.) relative to the tert-alcohol reagent was used because the byproduct water is also readily protonated by triflic acid reducing its reactivity. Excessive addition of triflic acid can cause gelation of the polymer. Since the reaction is exothermic, the reaction was conducted at 0° C.

To substitute the halide group, SEBS-C5-Br-0.8 (0.18 g) was dissolved in toluene (4 mL), filtered, and cast onto a glass plate. The dry SEBS-C5-Br-0.8 film (approximately 40 μm thick) was immersed in aqueous trimethylamine (45 wt % in water) at 45° C. for 48 h, The film was rinsed with water and ion exchanged to hydroxide form by immersing in 1M NaOH at room temperature for 48 h in an argon-filled glovebox.

The degree of functionalization (DF) of the PS block was controlled by changing the molar ratio of the tent-alcohol reagent to aromatic ring of the PS block. For example, a reaction with 0.5 eq. of the bromoalkylated tent-alcohol relative to PS block resulted in 50 mol % DF while a reaction with 1.0 eq. of the alcohol reagent resulted in 80 mol% DF, 95 mol % DF could be achieved for the PS block of SEBS when 2.0 eq. of the tent-alcohol was employed, however, the resulting quaternary ammonium (QA) membrane after the amination step (i.e. SEBS-05-TMA-0.95) exhibited instability. SEBS is a thermoplastic elastomer comprised of a soft poly(ethylene-co-butylene) (PEB) block and a hard PS block. Without wishing to be bound by theory, after incorporation of QA groups into the PS block, the water molecules absorbed in the PS block acted as a plasticizer to soften the hard block, resulting in the membrane with increased swelling and reduced mechanical strength. Thus, some balance between ion exchange capacity (WC) and mechanical properties is desirable.

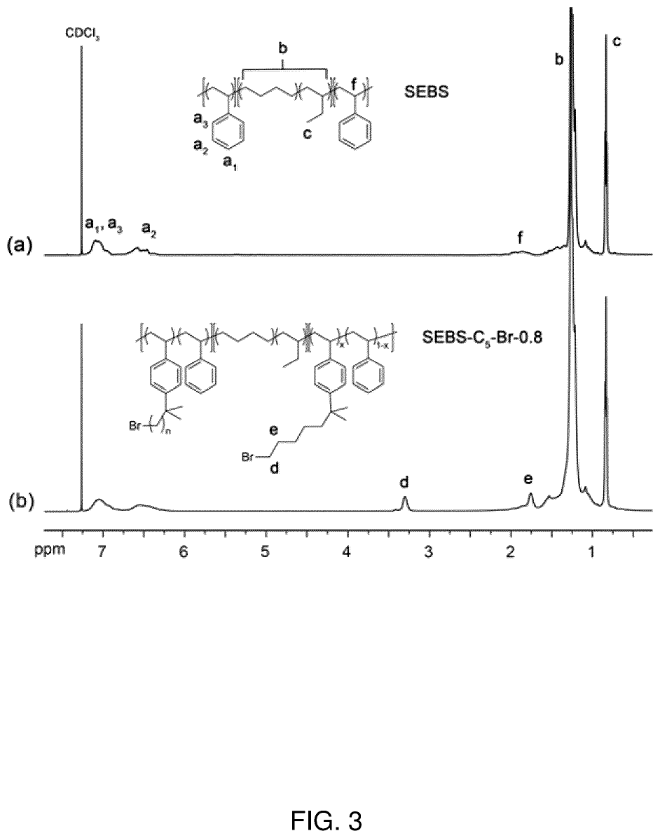

DFs were calculated by comparing proton integration values of the 1H NMR spectra. Referring now to FIG. 3, in the 1H NMR spectrum of pristine SEBS, the integration ratio of Ar-H₅ (peaks a₁₋₃ at 6.3-7.2 ppm), butylene-CH₃ (peak c at 0.7-0.9 ppm), and the other CH₂ and CH (peak b at 1.0-2.0 ppm) indicates that the molar ratios of styrene, ethylene, and butylene contents are 18 mol %, 51 mol % and 31 mol% , respectively. After Friedel-Crafts reaction with bromoalkylated alcohols, new proton signals of —CH₂Br at 3.2-3.3 ppm (peak d) along with the —CH₂CH₂Br signal (peak e) appeared. DB were calculated from the integration ratio of the —CH₂Br signal of the functionalized SEBS (peak d) and the butylene-CH₃ signal of the pristine SEBS (peak c).

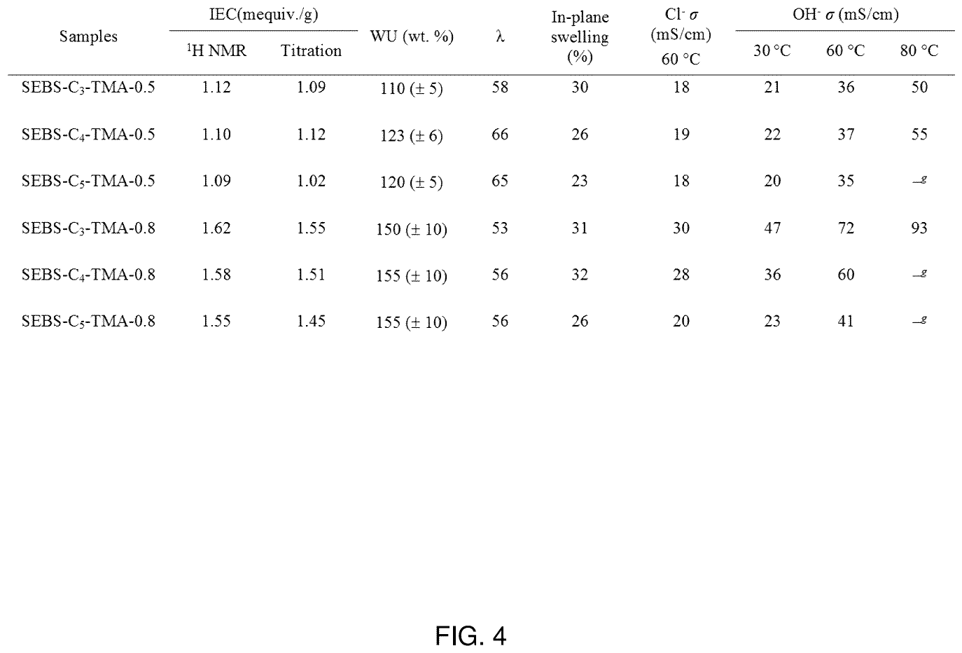

The tether length between the cation head group and the polymer backbone was controlled by modifying the alkyl chain length in the structure of brominated tent-alcohol. Referring now to FIG. 4, a series of bromoalkylated SEBSs with different tether lengths (n=3-5) and different DFs (50 and 80 mol % of PS block) were synthesized. NMR. based TECs are expected values of OH⁻ form calculated from the concentrations of bromoalkyl group in 1H NMR spectrum of SEBS-Cn-Br-x. Titration IECs values of SEBS-Cn-TMA-x were from Mohr titration method (average of two experiments). Water uptake was measured at room temperature in OW form (average of two measurements). Swelling was measured at room temperature in OH⁻ form. ⁻ σ were measured in water under argon atmosphere.

After amination of bromoalkyl side chains of SEBS-Cn-Br-x with trimethyl amine, the TMA-functionalized polymers, solubility became an issue. Therefore, films of SEBS-Cn-Br-x were cast from a 5 wt. % toluene solution on a glass plate (membrane thickness: 40-50 μm), and subsequent amination was performed by immersing the membranes in an aqueous trimethylamine solution. Completion of the reaction was confirmed by titrated IEC and infrared spectroscopy. The SEBS-Cₙ-TMA-x membranes were flexible, elastomeric, colorless and transparent.

### Example 2: Preparation with Haloalkylated Alkenes.

Related to the Friedel-Crafts reaction from bromoalkylated tertiary alcohols and SEBS from Example 1, but without wishing to be bound by theory, similar carbocation intermediates could be formed by protonation of an alkene. Unlike the case of alcohol substrates where released water byproduct can be protonated by triflic acid, no such byproduct is generated from the reaction with alkene substrates. Thus, less amount of triflic acid catalyst was used. For example, while 1.1-1.2 equivalent amount of triflic acid was used for the bromoalkylation with alcohol substrates in Example 1, 0.33 equivalent amount of triflic acid was used to induce the bromoalkylation reaction of alkene reagents.

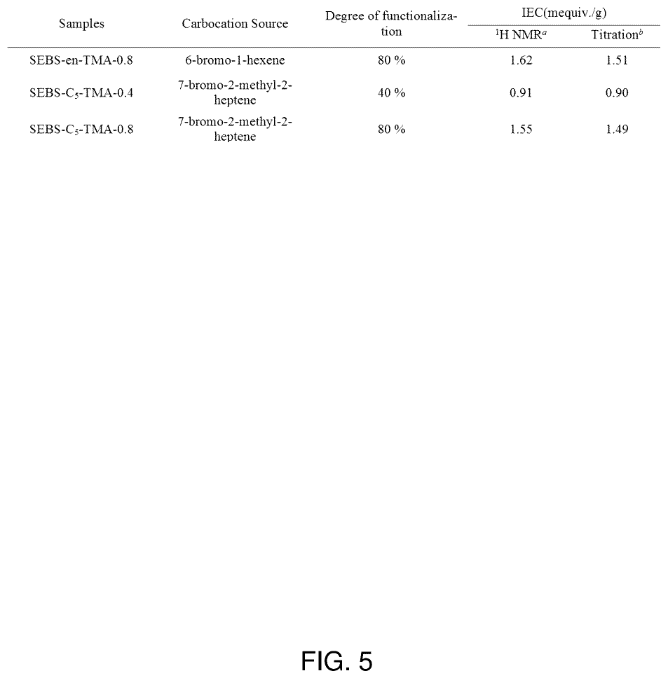

6-bromo-l-hexene and 7-bromo-2-methyl-2-heptene were evaluated for the Friedel-Crafts bromoalkylation with SEBS. DF was controlled by adjusting the amount of bromoalkenes similar to the reaction with tert-alcohol. As protonation of 7-bromo-2-methyl-2-heptene would form the tertiary carbocation intermediate generated from 7-bromo-2-methyl-2-heptanol, it resulted in the same QA SEBS after amination with TMA. However, without wishing to be bound by theory, the protonation of 6-bromo-l-hexene generates a secondary carbocation at C2 initially, which can rearrange to form another secondary carbocation at C3. Thus, a mixture of C2- and C3-tethered bromoalkyl chains was attached to SEBS from the reaction with 6-bromo-l-hexene. Referring now to FIG. 5, following treatment by trimethylamine, the resulting QA polymer (e.g. SEBS-en-TMA-0.8) showed a titrated IEC that agrees well with NMR based IECs from the DF. MR based IECs are expected values of OH⁻ form calculated from the concentrations of bromoalkyl group in 1H MR spectrum of SEBS-Cn-Br-x. Titration IECs values of SEBS-Cn-TMA-x were from Mohr titration method (average of two experiments). Since a variety of bromoalkenes are commercially available or readily obtainable, this polymer functionalization methodology can be adopted to create different structures of QA-tethered aromatic polymers in an atom-economic synthesis without generating byproducts.

### OTHER EMBODIMENTS

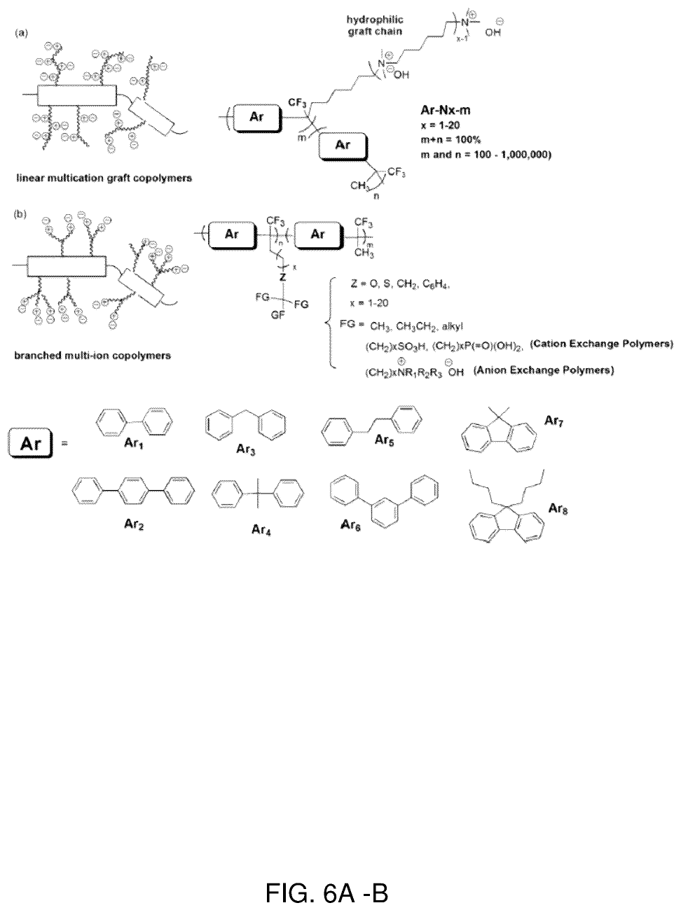

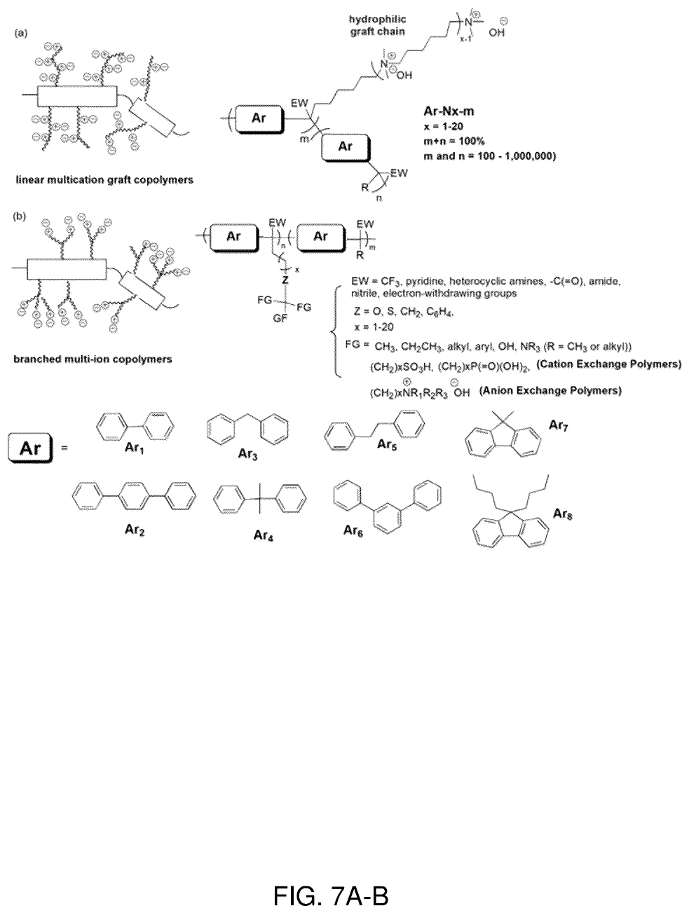

Referring now to FIGS. 6A-7B, some embodiments of the present disclosure are directed to ion exchange membranes composed of one or more polymers. In some embodiments, the one or more polymers include a polymeric backbone with one or more ions and/or ionic groups, e.g., in one or more side chains along the backbone. In some embodiments, the polymeric backbone includes one or more polyarylenes. In some embodiments, these cationic and anion exchange membranes (CEM and AEM, respectively) polymers do not have ether linkages (—O—) in the polymer main-chain. In some embodiments, one or more multi-ion groups are incorporated onto the polymer side chains. In some embodiments, the side chains include one or more alkyl groups. In some embodiments, the polymer includes linear side chains, branched side chains, or both linear side chains and branched side chains. Specifically referring to FIGS. 6A and 7A, a linear multication graft copolymer consistent with some embodiments of the present disclosure is shown. Specifically referring to FIG. 6B and 7B, a branched multi-ion copolymer (cation and anion) consistent with some embodiments of the present disclosure is shown. In some embodiments, the side chains are about the same length as the polymer backbone.

In some embodiments, the polyarylenes are produced via from polycondensation reactions of aromatic compounds and trifluoroalkyl ketones using strong acid, e.g., trifluorosulfonic acid (TFSA).

Methods and systems of the present disclosure are advantageous to provide better performing ion-exchange membranes for a wide variety of uses, e.g., alkaline exchange membrane fuel cells, alkaline exchange membrane electrolysis, actuator, battery, and other electrochemical energy conversion/storage applications, water purification. Because ionic groups are clustered in the membrane structure, these ion exchange polymers are expected to provide better transport of ions via ionic-water channels and better stability in alkaline conditions. Further, a wide variety of ionic groups can be incorporated into the ether-free backbone polymers. Finally, the polymers of the present disclosure overcome the alkaline stability issue of AEMs by stabilizing the polymer structure and incorporating more robust cationic groups.

In another aspect, a polymer according to formula IV, is provided.

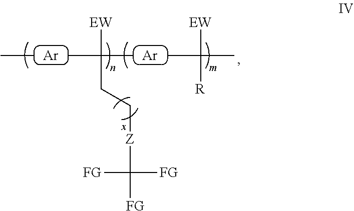

wherein Ar is an aryl;
Z is selected from the group consisting of O, S, CH₂, and C₆H₄;
R is an alkyl;
FG comprises a moiety selected from the group consisting of an alkyl, an aryl, OH, a sulfonate, a phosphonate, and a quaternary ammonium group, wherein at least one FG comprises an ionic moiety;
EW comprises a moiety selected from the group consisting of an electron-withdrawing group, CF₃, a nitrile, an amide, a pyridine, a heterocyclic amine, —C═O, and an amide;
x is from 1 to 20;
n and m are each independently from 100 to 1,000,000.

In some embodiments, the polymer of formula IV is an anion exchange polymer. In some embodiments, at least one FG comprises a quaternary ammonium group. For example, at least one FG may include (CH₂)ₓ·N⁺R₁R₂R₃, wherein R₁, R₂, and R₃ is each an alkyl (e.g., methyl). In some embodiments EW is CF₃. In some embodiments, Ar in formula IV includes

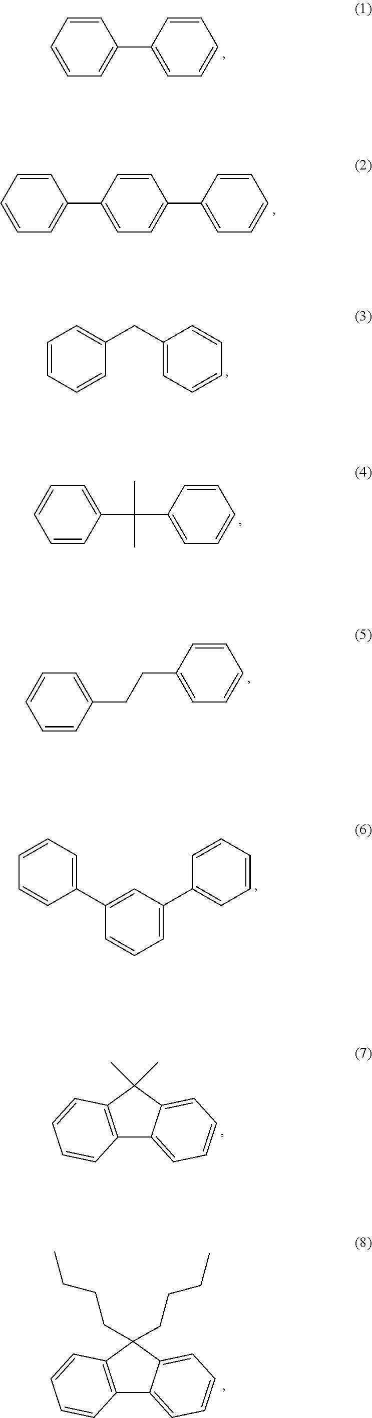

or combinations thereof.

In some embodiments the polymer of formula IV has formula V:

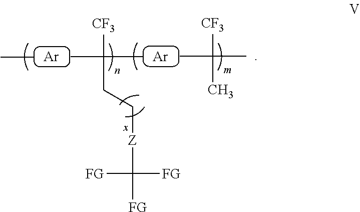

In some embodiments, the polymer is a cation exchange polymer. In some embodiments, at least two FGs in a repeating unit include an ionic moiety. In some embodiments, at least three FGs in a repeating unit include an ionic moiety.

In another aspect, a polymer according to formula VI, is provided:

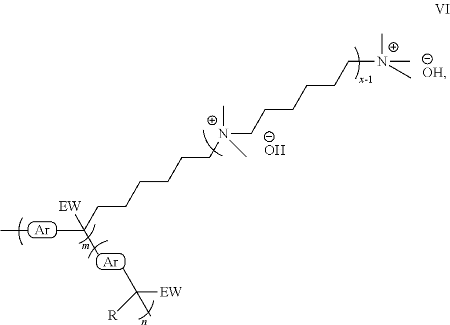

wherein Ar is an aryl;
R is an alkyl;
EW comprises a moiety selected from the group consisting of an electron-withdrawing group, CF₃, a nitrile, an amide, a pyridine, a heterocyclic amine, —C═O, and an amide;
x is from 1 to 20;
n and m are each independently from 100 to 1,000,000.

In some embodiments EW is CF₃. In some embodiments Ar in formula VI includes

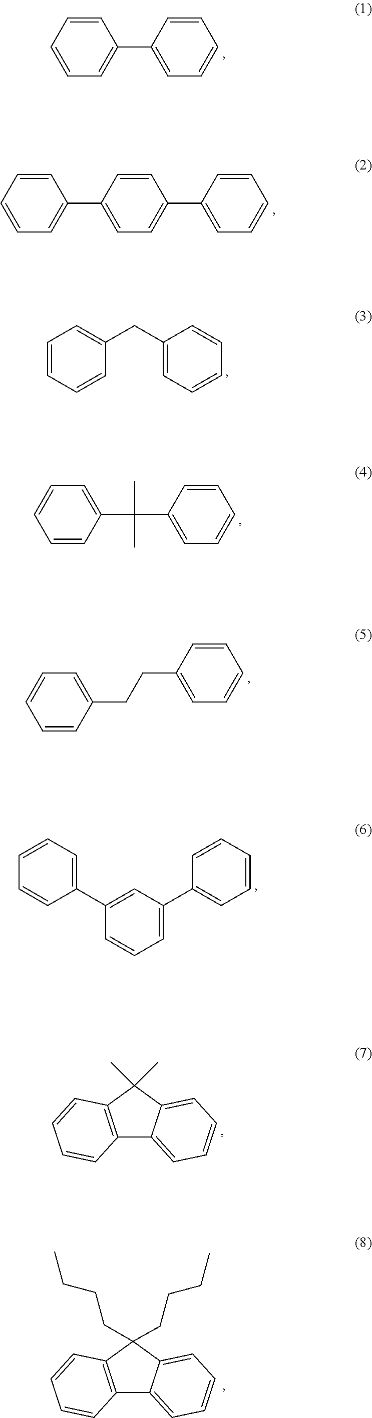

or combinations thereof.

In some embodiments the polymer of formula VI has formula VII:

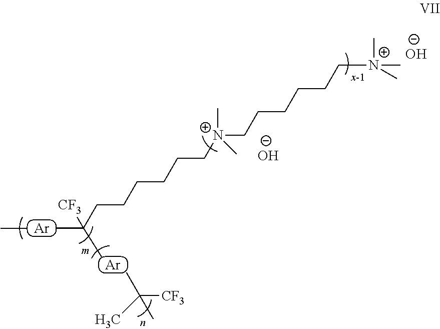

In another aspect, a polymer according to formula VIII, is provided:

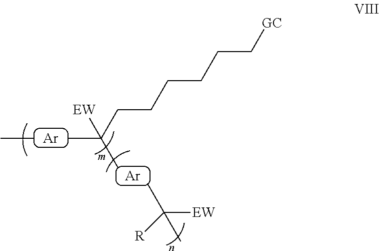

wherein GC is a graft chain comprising multiple ionic moieties;
wherein Ar is an aryl;
R is an alkyl;
EW comprises a moiety selected from the group consisting of an electron-withdrawing group, CF₃, a nitrile, an amide, a pyridine, a heterocyclic amine, —C═O, and an amide;
x is from 1 to 20;
n and m are each independently from 100 to 1,000,000.

In some embodiments the multiple ionic moieties include multiple quaternary ammonium groups. In some embodiments EW is CF₃. In some embodiments Ar in formula VIII includes:

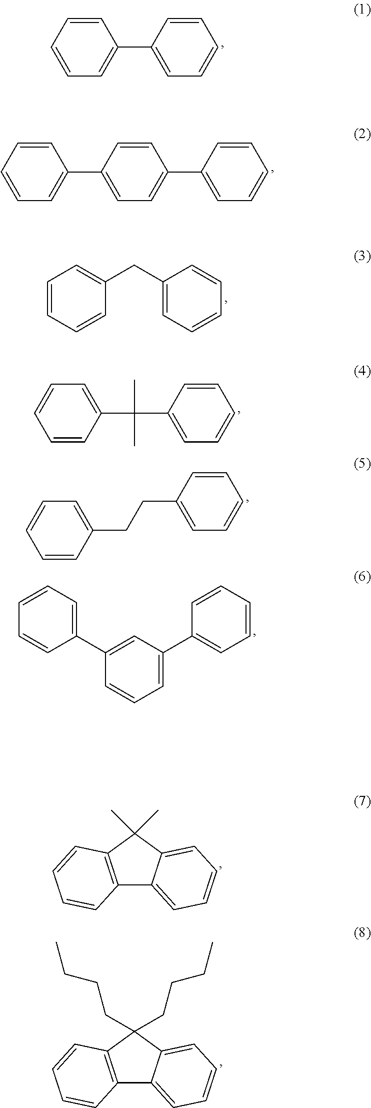

or combinations thereof.

In some embodiments R is an alkyl and EW is CF₃.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

What is claimed is:

1. A polymer according to formula IV: 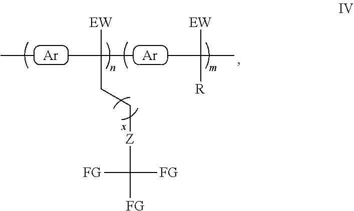
wherein Ar is an aryl;
Z is selected from the group consisting of O, S, CH₂, and C₆H₄;
R is an alkyl;
FG comprises a moiety selected from the group consisting of an alkyl, an aryl, OH, a sulfonate, a phosphonate, and a quaternary ammonium group, wherein at least one FG comprises an ionic moiety;
EW comprises a moiety selected from the group consisting of an electron-withdrawing group, CF₃, a nitrile, an amide, a pyridine, a heterocyclic amine, —C═O, and an amide;
x is from 1 to 20;
n and m are each independently from 100 to 1,000,000.

2. The polymer of claim 1, wherein the polymer is an anion exchange polymer.

3. The polymer of claim 1, wherein at least one FG comprises a quaternary ammonium group.

4. The polymer of claim 1, wherein at least one FG comprises (CH₂)ₓ·N⁺R₁R₂R₃, wherein R₁, R₂, and R₃ is each an alkyl.

5. The polymer of claim 4, wherein R₁, R₂, and R₃ is each methyl.

6. The polymer of claim 4, wherein EW is CF₃.

7. The polymer of claim 1, wherein Ar includes 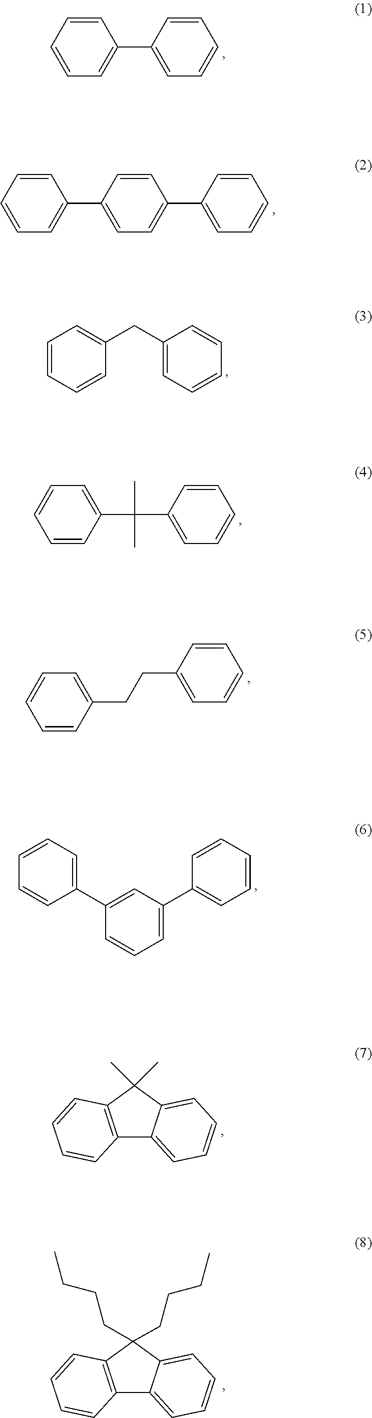
or combinations thereof.

8. The polymer of claim 1, wherein the polymer has formula V

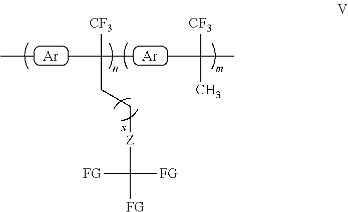

9. The polymer of claim 1, wherein the polymer is a cation exchange polymer.

10. The polymer of claim 1, wherein at least two FGs in a repeating unit comprise an ionic moiety.

11. The polymer of claim 1, wherein at least three FGs in a repeating unit comprise an ionic moiety.

12. A polymer according to formula VI: 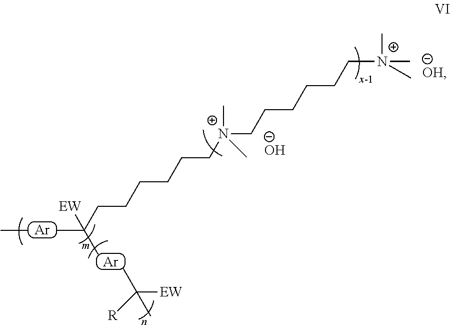
wherein Ar is an aryl;
R is an alkyl;
EW comprises a moiety selected from the group consisting of an electron-withdrawing group, CF₃, a nitrile, an amide, a pyridine, a heterocyclic amine, —C═O, and an amide;
x is from 1 to 20;
n and m are each independently from 100 to 1,000,000.

13. The polymer of claim 12, wherein EW is CF₃.

14. The polymer of claim 12, wherein Ar includes 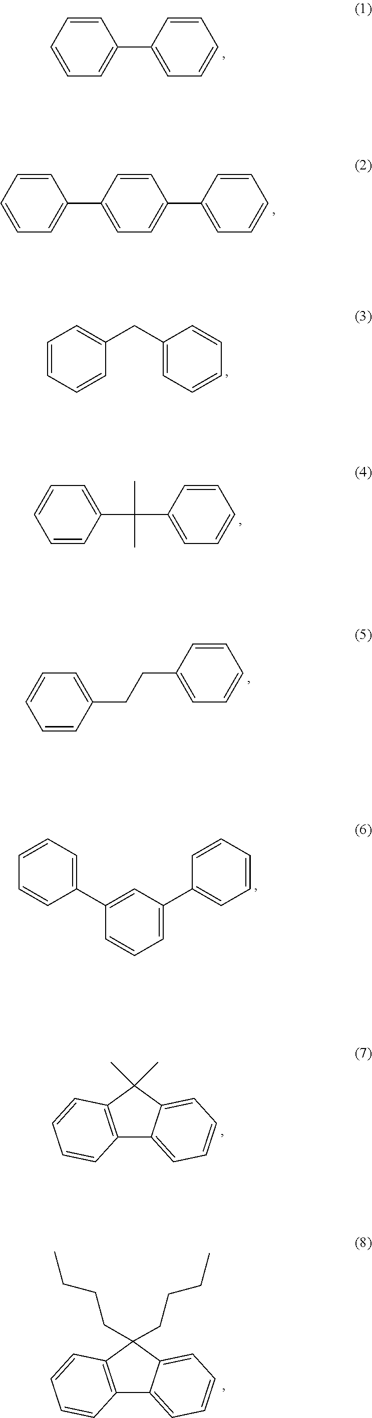
or combinations thereof.

15. The polymer of claim 12, wherein the polymer has formula VII:

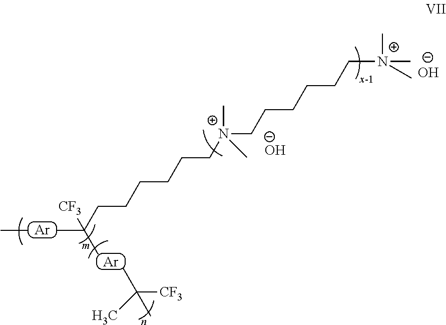

16. A polymer according to formula VIII 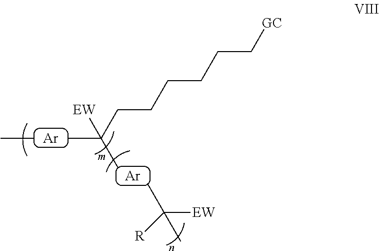
wherein GC is a graft chain comprising multiple ionic moieties;
wherein Ar is an aryl;
R is an alkyl;
EW comprises a moiety selected from the group consisting of an electron-withdrawing group, CF₃, a nitrile, an amide, a pyridine, a heterocyclic amine, —C═O, and an amide;
x is from 1 to 20;
n and m are each independently from 100 to 1,000,000.

17. The polymer of claim 16, wherein the multiple ionic moieties include multiple quaternary ammonium groups.

18. The polymer of claim 16, wherein EW is CF₃.

19. The polymer of claim 16, wherein Ar includes 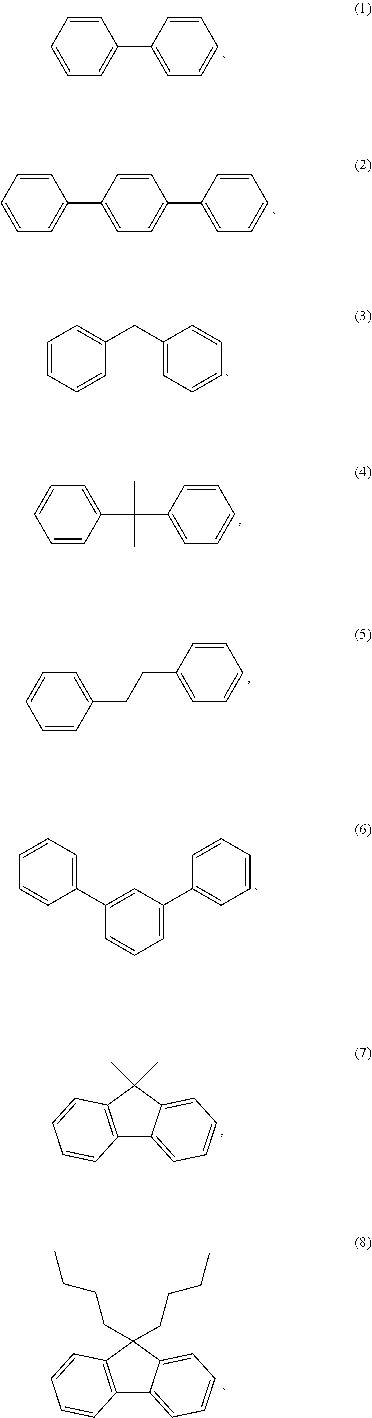
or combinations thereof.

20. The polymer of claim 16, wherein R is an alkyl and EW is CF₃.
